(19) United States
(12) Patent Application Publication
(10) Pub. No.: US 2009/0091650 A1
(43) Pub. Date: Apr. 9, 2009

(54) DIGITAL CAMERA CAPABLE OF APPROPRIATELY DISCRIMINATING THE FACE OF A PERSON

(75) Inventor: Kazushi KODAMA, Miyagi (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/242,201

(22) Filed: Sep. 30, 2008

(30) Foreign Application Priority Data
Oct. 1, 2007 (JP) 2007-257998

(51) Int. Cl. H04N 5/222

(52) U.S. Cl. 348/333.11; 348/E05.022

(57) ABSTRACT

In a digital camera, when a shutter button is depressed into its half stroke, a subject is photographed as a preparatory image, in which the face of a person is identified as a face area. Such a face area at the latest time is compared with a corresponding face area in another preparatory image taken immediately preceding to the latest time. If no substantial difference exists between both, the face area is determined as a stationary object and excluded from a set of identified face areas, of which the remaining ones are adopted as the face areas selected, based on which, optimum exposure and focusing values are calculated. When the shutter button is depressed into its full stroke, the calculated optimum exposure is carried out with the optimum focusing value to photograph a subject as a live image. The face area of the subject is freely selectable.

### BACKGROUND OF THE INVENTION

1. Field of the Invention

The present invention relates to a digital camera and, more particularly, to a digital camera having the function of selecting, from image data, a face area or areas of interest for an operator, and a method for photographing with the camera.

2. Description of the Background Art

In general, when the lens of a digital camera is directed to a person in order to photograph him or her as a subject, the digital camera first captures the subject as a preparatory image. The digital camera then detects a face area from the preparatory image and, based on the face area or areas, determines photographing conditions, thereafter proceeding to live photographing. A variety of techniques have so far been proposed in connection with this sequence of operations. For example, in Japanese laid-open publication 2005-156967, there is disclosed a digital camera, in which a face area or areas is detected from a preparatory image, and one or ones of the face areas corresponding to the number appropriate for the photographing mode is or are selected to use the face area or areas thus selected to determine a photographing condition, under which the photographing is carried out.

With this conventional method, the number of the face areas is fixedly dedicated to a photographing mode, such that, whenever the camera is in its portrait mode, all of the face areas will be selected. As a result, the face area of a person or persons, which is not intended to be photographed, is selected as a subject to be photographed, and the photographing conditions, such as exposure value, are determined accordingly. Thus, a problem is raised that photographing takes place under conditions not intended by the operator. Moreover, person-like subjects, such as a poster including the face of a person or a statue of a person, are detected as a face area as a subject for photographing. The photographing conditions are thus determined with such person-like subjects included as a photographing subject, so that photographing is effected under conditions not intended by the operator.

### SUMMARY OF THE INVENTION

It is therefore an object of the present invention to provide a digital camera in which the face area or areas of a subject to be photographed may be selected at will, and more specifically to provide a digital camera in which a person-like stationary object, such as a person's poster or a bronze statue, may be excluded from selection of the face area or areas of the subject to be photographed to render it possible to perform the photographing as intended by the operator.

It is another object of the present invention to provide a digital camera in which it is possible to exclude a person who has not changed in his or her facial expressions or whose eyes have not blinked for a certain period of time from the face area selection as a subject to be photographed, thereby enabling the photographing as intended by the operator.

According to the present invention, the subject of photographing is photographed as a preparatory image when the shutter is depressed into its half stroke. The face of a person of the preparatory image is identified as a face area. The face area of the latest preparatory image and the corresponding face area of the immediately preceding preparatory image are compared with each other. If there is substantially no difference between the face areas of the two preparatory images, the face area is determined to be a stationary subject and excluded from selection of the identified face areas, and the remaining identified face areas are adopted as selected face areas. An optimum exposure and an optimum focusing value are calculated based on the so selected face areas. When the shutter release button is depressed into its full stroke, a subject of photographing is photographed as a live image based on the optimum exposure and optimum focusing values. The face areas of the subject of photographing may freely be selected by touch pen unit, cursor unit or speech recognition subsection.

According to the present invention, there is provided a digital camera including an imaging unit for photographing a subject field to produce an image signal representing the subject field, and a shutter operating unit. When the shutter release button is depressed into its half stroke, the shutter operating unit instructs capturing a preparatory image. When the button is depressed into its full stroke, the shutter operating unit instructs capturing a live image. The camera includes a controller for controlling the imaging unit to photograph the subject field at the first time when the shutter release button is depressed into its half stroke to produce preparatory image data, and to photograph the subject field at the second time when the shutter release button is depressed into its full stroke to produce live image data. The camera also includes an image data storage for storing the preparatory image data and the live image data, and a face area recognition subsection for recognizing a pattern equivalent to the face of a person in the so stored preparatory image, identifying the pattern as a face area, and affording face area discriminating data for the face area. The camera also includes a difference calculator for comparing a face area of interest in the preparatory image at a time point closest to the current time point with the corresponding face area in the preparatory image at a time point immediately preceding to the closest time point, and for calculating the difference therebetween. The camera further includes a face area selector for determining the face area to be a stationary object, in case the difference is substantially equal to zero, and for excluding the face area from face area selection. The camera also includes a display unit for visually displaying the preparatory image at the closest time point for displaying the selected face area in the preparatory image with emphasis. The controller instructs the imaging unit, at the second time, to perform live photographing of the subject field with an optimum exposure and an optimum focus value based on the selected face area.

According to the present invention, the face area selector has a stationary object identifying value for each of the face areas of the preparatory image. The stationary object identifying value has its initial value equal to a natural number N. The face area selector adds a value of −1 to the identifying value in case the difference is substantially equal to zero, while adding a value of +1 to the identifying value in case the difference is different substantially from zero. The face area selector performs the addition at least N cycles. When the identifying value is equal to zero, the face area selector determines the face area to be a stationary object to eliminate the face area of interest from face area selection.

According to the present invention, the digital camera further includes a light illumination unit for illuminating light to a subject field. When the camera is set to a light illumination mode, the controller controls the light illumination unit to illuminate light at the first time, while controlling the imaging unit to photograph a subject, in synchronization with the light illumination, as a preparatory image. The face area selector determines that a face area in the preparatory image synchronized with the light illumination and a corresponding face area in the immediately preceding preparatory image, having the difference substantially equal to zero, represent a stationary object. The face area selector then excludes the face area from face area selection.

According to the present invention, the difference calculator determines that a face area in the preparatory image synchronized with the light illumination and the corresponding face area in the immediately preceding preparatory image having the difference greater than a predetermined value in the vicinity of the eye represent a face area where the light has been reflected by spectacles. The light illumination unit then may not be driven at the second time.

According to the present invention, there is also provided a method for photographing with a digital camera including an imaging unit for photographing a subject field to produce an image signal representing the subject field, and a shutter operating unit. The shutter operating unit instructs capturing a preparatory image at the first time when the shutter release button is depressed into its half stroke, while instructing capturing a live image at the second time when the shutter release button is depressed into its full stroke. The method for photographing includes first to tenth steps. The first step commands capturing a preparatory image at the first time, and the second step photographs a subject as a preparatory image, based on a photographing command, to produce preparatory image data. The third step stores the preparatory image data produced, and the fourth step recognizes the face of a person in the so stored preparatory image data to identify the face as a face area, and affords face area discriminating data to the face area. The fifth step visually displays a preparatory image at a time point closest to the current time point, and the sixth step compares a face area of interest in the preparatory image at the closest time point with a corresponding face area in a preparatory image immediately preceding to the closest time point to calculate a difference therebetween. The seventh step determines the identified face area of interest as a stationary object when the difference is substantially equal to zero to eliminate the face area of interest from face area selection, and selects the identified face area as a selected face area when the difference is not zero. The eighth step displays the selected face area with emphasis in the preparatory image at the latest time point displayed. The ninth step calculates an optimum exposure and an optimum focusing based on the selected face area, and the tenth step captures a live image of the subject field at the optimum exposure and focusing values at the second time.

With the digital camera of the present invention, the subject desired to be photographed, such as a person or persons, may freely be selected from an display screen. Exposure and focusing may then be automatically performed according to the subject such as the selected person or persons. Hence, the person or persons selected are photographed clearly, while the person or persons not selected are photographed softly, thus enabling photographing as intended by the operator.

The present invention may be applied with utmost advantage to a sector where it is necessary to freely select a subject, such as a person or persons, from the display screen, and to effect automatic exposure or focusing in keeping with the subject, herein the person or persons. Such a sector may, for example, be of a digital camera or a mobile phone terminal that is in need of automatic exposure or focusing techniques.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the constitution of a first embodiment of a digital camera according to the present invention;

FIG. 2 is simplified views useful for understanding the state of identifying face areas by the digital camera according to the illustrative embodiment shown in FIG. 1;

FIG. 3 is simplified views useful for understanding the state of excluding a face area erroneously recognized by the digital camera from face area selection according to the illustrative embodiment;

FIG. 4 is simplified views useful for understanding the state of excluding the state of excluding a face area erroneously recognized due to light illumination by the digital camera from face area selection according to the illustrative embodiment;

FIG. 5 is simplified views useful for understanding how the light illumination reflected by spectacles is detected by the digital camera according to the illustrative embodiment;

FIGS. 6, 7 and 8 are a flowchart useful for understanding the operational flow of the first embodiment;

FIG. 9 is a schematic block diagram, like FIG. 1, showing the constitution of a second embodiment of a digital camera according to the illustrative embodiment;

FIG. 10 is simplified views useful for understanding the state of excluding a face area from face area selection by a touch pen according to the second embodiment;

FIG. 11 is simplified views useful for understanding the state of selecting a face area by the touch pen according to the second embodiment;

FIGS. 12, 13 and 14 are an operational flowchart useful for understanding an operational flow of the second embodiment;

FIG. 15 is a schematic block diagram, like FIG. 1, showing the constitution of a third embodiment of a digital camera according to the present invention;

FIGS. 16, 17 and 18 are an operational flowchart useful for understanding an operational flow of the third embodiment;

FIG. 19 is a schematic block diagram, like FIG. 1, showing the constitution of a fourth embodiment of a digital camera according to the present invention;

FIG. 20 is simplified views useful for understanding the state of selecting a face area by speech recognition according to the fourth embodiment;

FIGS. 21 and 22 are an operational flowchart useful for understanding an operational flow of the fourth embodiment;

FIG. 23 is a schematic block diagram, like FIG. 1, showing the constitution of a fifth embodiment of a digital camera according to the present invention;

FIG. 24 is schematic views useful for understanding the state of selecting a face area by designation of partitioned areas according to the fifth embodiment; and

FIGS. 25, 26 and 27 are an operational flowchart useful for understanding an operational flow of the fifth embodiment.

### DESCRIPTION OF THE PREFERRED EMBODIMENTS

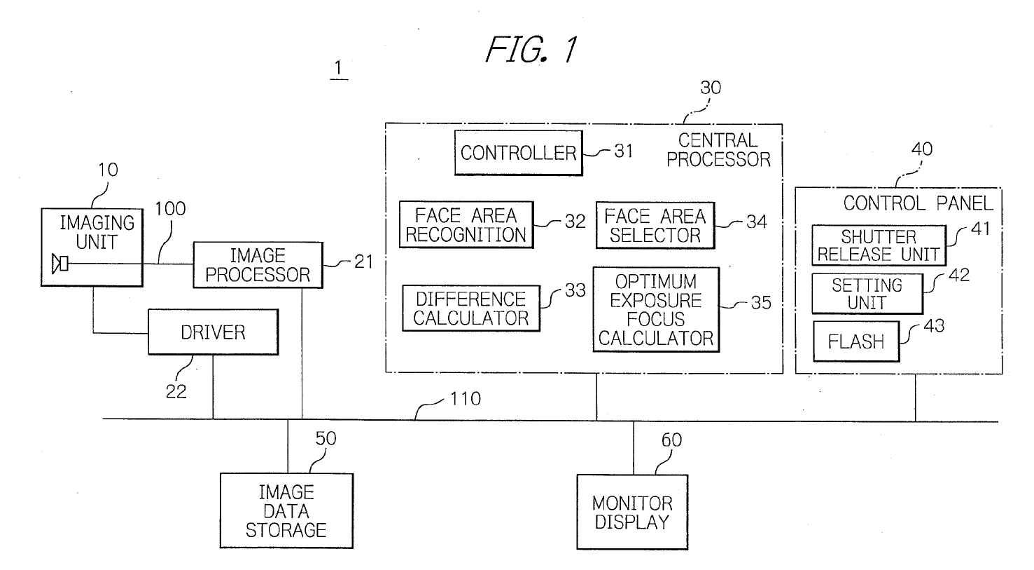

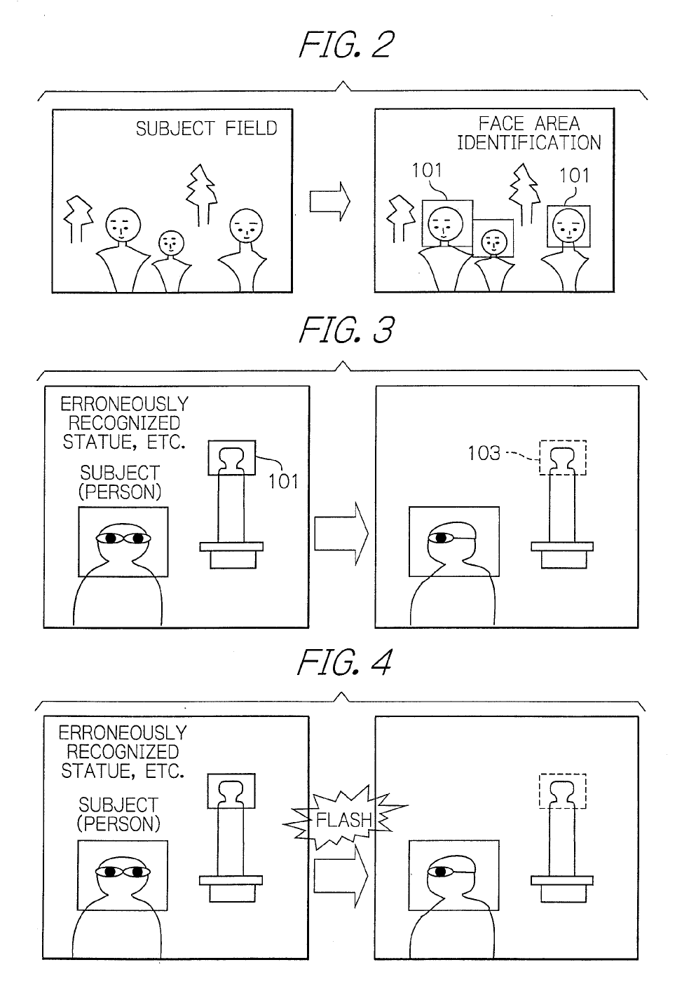

With reference to the accompanying drawings, preferred embodiments of the present invention will be described in detail. Initially, a first illustrative embodiment of a digital camera according to the present invention will be described with reference to FIG. 1, showing its constitution, and to the simplified sketch of FIG. 2.

The digital camera 1 of the first embodiment generally includes an imaging unit 10, an image processor 21, a driver 22, a central processor 30, a control panel or consol 40, an image data storage 50 and a monitor display 60, which are interconnected as shown. The imaging unit 10 and the image processor 21 are interconnected by a connection line 100. The respective sections including the image processor 21 and the image data storage 50 are interconnected over an internal bus 110.

The imaging unit 10 has optical functions, such as an imaging lens, a mechanical shutter and a diaphragm, and is provided with a photographing system, inclusive of a solid-state image sensor, such as a charge-coupled device (CCD) or metal-oxide semiconductor (MOS) type of sensor. The imaging unit 10 is driven by the driver 22 responsive to commands provided from the central processor 30 to photograph a subject as a preparatory image or as a live image. The so obtained image is sent to the image processor 21 in the form of image data. The driver 22 is a functional section that drives the imaging unit 10 in response to commands from the central processor 30.

The image processor 21 is adapted for performing signal processing, such as color compensation, gray scale or gradation control and white balance adjustment, on photographed image data captured by the imaging unit 10 and converted into digital values. The image data captured are sent to the image data storage 50. The imaging unit 10, image processor 21 and driver 22 make up a photographing section.

The image data storage 50 includes a rewritable temporary storage area, not shown, and functions an image data holding circuit for holding digitized image data.

The central processor 30, made up by a controller 31, a face area recognition subsection 32, a difference calculator 33, a face area selector 34 and an optimum exposure focus calculator 35, comprehensively controls the operation of the entire digital camera 1. Specifically, the central processor is responsive to operational commands provided from the control panel 40 to control the imaging unit 10 in capturing a preparatory image or a live image, and to effect selective recognition of the face area, as characteristic of the present embodiment. The controller 31 controls the various parts, connected to the internal bus 110, while also controlling the face area recognition subsection 32, difference calculator 33, face area selector 34 and optimum exposure focus calculator 35.

The face area recognition subsection 32 is adapted to recognize the face of a person included in a preparatory image captured and identifies the face of such a person as a face area. The monitor display 60 is controlled to display on its screen, not shown, the so identified face area, with its luminance emphasized, or encircled with an indicator, such as a rectangular frame 101, as shown in FIG. 2, by way of visually demonstrating the emphasized state.

The difference calculator 33 is adapted to compare respective face areas in a preparatory image captured at the latest time point to the face areas in a preparatory image captured at a time point immediately preceding to the latest time point. More specifically, the face areas of two preparatory images neighboring to each other on the time axis are compared to each other to thereby calculate the difference therebetween. The so calculated values of the resulting difference data are then output from the calculator 33.

The face area selector 34 is adapted for checking the difference data output by the difference calculator 33. In case the difference is substantially zero, the face area selector 34 gives a decision that the subject of photographing is a stationary object and removes it from face area selection. In order to improve the precision in determining the face area, the face area selector 34 may have a stationary object identifying quantity Q, having its initial value N predetermined, for each of the face areas of the preparatory image, where N is preferably a natural number. In this case, the face area selector adds a value of −1 to, or decrements, the quantity Q if the difference value of the difference data is substantially zero, whereas adding a value of +1 to, or incrementing, the quantity Q if the difference value is not zero. This addition operation is performed at least N cycles. If, at some time point during the N cycles of the addition operation, the quantity Q is equal to zero, the face area selector 34 makes a decision that the subject being photographed is a stationary object and eliminates it from face area selection.

As a further hardware-related function, the digital camera 1 may have a predetermined value M representing the maximum number of persons for recognition, equal to or below which an operator may set, in one of the photographing modes, a peak number of persons for recognition P. The face area selector 34 is operable to select the face areas, with the number of the face areas for selection not exceeding the peak number of persons for recognition P. The optimum exposure focus calculator 35 is adapted to calculate an optimum exposure value, i.e. exposure time multiplied by stop value, and an optimum focusing value, based on the so selected face areas. The controller 31 serves as issuing photographing commands to the driver 22, via the controller 31, based on the so calculated optimum exposure and focusing values.

The control panel 40 has the interfacing function for the operation of the digital camera 1 and for the setting of the photographing modes, and includes a shutter release unit 41, a setting unit 42 and a flash unit 43 adapted for manually setting values. The shutter release unit 41 includes a shutter release button, not shown, for an operator to instruct photographing. The shutter release button is a two-stroke operating member manipulable into a half and a full stroke. When the shutter release button is depressed into its half stroke, the shutter release unit 41 issues a command for capturing a preparatory image to the driving unit 22 via the controller 31. When the shutter release button is depressed into its full stroke, the shutter release unit 41 issues a command for capturing a live image via the controller 31 to the driver 22.

The setting unit 42 is operative in response to setting values set or input thereon by an operator to cause appropriate portions of the camera 1 to operate accordingly. For example, in order to allow the camera 1 to automatically proceed to flash illumination in case the luminance falls to a predetermined value or below when photographing, the operator may manipulate the setting unit 42 so as to set the ‘flash’ item of the setting mode to ‘automatic flash’. The setting may be performed by any one of known methods.

The flash unit 43 includes a flash illuminating member, not shown. When the ‘flash’ item of the setting mode is the “flash illumination” mode, flash illumination is effected in response to the shutter release button depressed into its half stroke and also into its full stroke.

The monitor display 60 includes a video display screen, not shown, for displaying a through-image, that is, a preparatory image, and a live image, and may be any of routine display devices including a liquid crystal display (LCD) device. The monitor display 60 may also be designed to visually display various settings of the setting mode on the screen. The monitor display 60 may be provided with a touch panel which is adapted to sense a touch pen, when touching the display screen, to output touch pen data, as will be described subsequently. Cursor data may also be output in response to the display screen pointed with a cursor.

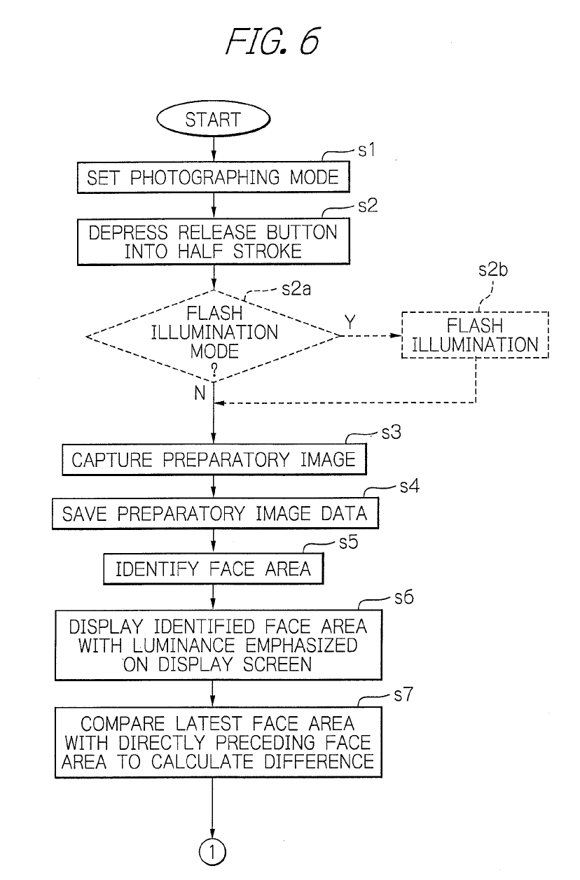

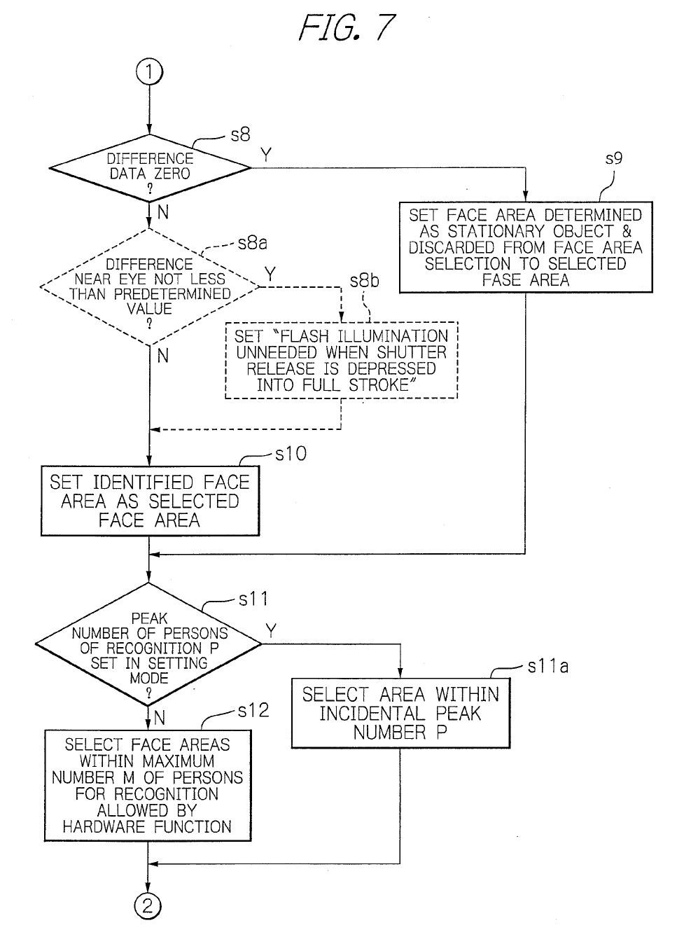

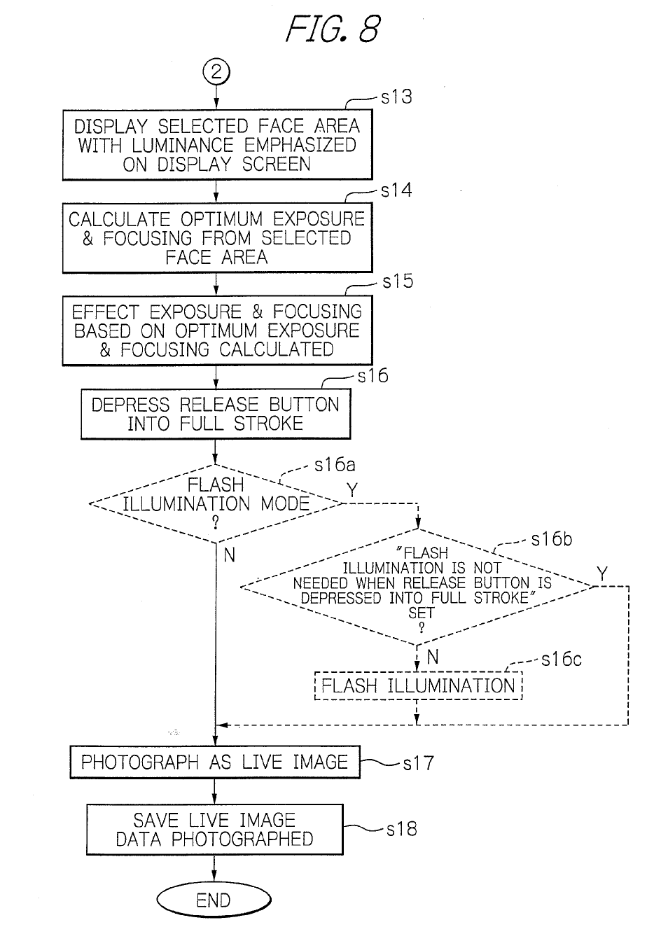

The operation of the digital camera of the present embodiment will now be described in detail with reference to the sketches of FIGS. 2 to 5 and the operational flowcharts of FIGS. 6, 7 and 8. It should be noted that, in the operational flowcharts of FIGS. 6, 7 and 8, dotted lines indicate portions of the control flow which act in the flash mode set.

Initially, when an operator thrusts a power supply button, not shown, of the digital camera 1, or opens a lens cover, not shown, the main power supply of the camera is turned on. Respective items of the setting mode, displayed on the display screen of the monitor display 60, are then set (step s1).

The operator then directs the digital camera 1 to a subject being photographed and depresses the shutter release button into its half stroke. In response to the shutter release button depressed into its half stroke, the shutter release unit 41 of the control panel 40 notifies the central processor 30 of the fact that the preparatory imaging step is predominant. The central processor 30 accordingly commands the driver 22 to capture a preparatory image (step s2).

Responsive to this command, the driver 22 commands the imaging unit 10 to capture the preparatory image. The imaging unit 10 photographs a subject under predetermined photographing conditions to generate an image signal of the preparatory image. The so photographed image signal is converted to corresponding digital values which are in turn sent to the image processor 21.

The image processor 21 performs image processing required for the preparatory image data received to have the so processed image data stored in the image data storage 50 (step s3). The image data storage 50 holds the data of preparatory image (step s4). The image data storage 50 notifies the central processor 30 of the completion of the storing of the preparatory image. At the same time, the preparatory image data are sent to the monitor display 60 so as to be visually displayed on its monitor screen as a so-called through-image. On receipt of the notification of the storing completion, the controller 31 of the central processor 30 commands the face area recognition subsection 32 to recognize the pattern of a person involved in the preparatory image to specify the pattern as the face area.

The face area recognition subsection 32 is responsive to this command to recognize the person of the preparatory image, and identifies the pattern, recognized as the human being, as being the face area. The face area recognition subsection 32 then notifies the controller 31 of the completion of identification (step s5). The way of person recognition may be by any known method, such as by discriminating the skin color. Responsive to this notification of the completion of person recognition, the controller 31 commands the monitor display 60, over the internal bus 110, to display the preparatory image on the monitor screen with the specified face area discriminatively indicated from the remaining portion, such as by emphasizing its luminance.

The monitor display 60 receives data of the preparatory image from the image processor 21 to dynamically display the data in the form of through-image on the display screen. The monitor display 60 is responsive to the above-mentioned discriminative indication to display the specified face area of the preparatory image with its luminance emphasized (step s6). Although the specified face area of the preparatory image is displayed in the present embodiment with its luminance emphasized, such area of the preparatory image may instead or additionally be emphatically displayed by other methods whereby the operator may easily specify or identify the so identified face area in the preparatory image. Such other methods may include surrounding the outer contour line of the face area with a curved line flickering, or by luminance inverted, as indicated in FIG. 2.

The controller 31 commands the difference calculator 33 to calculate the difference of the face areas. The difference calculator 33 compares the face area of the preparatory image at the latest recognition time point and the same face area at a time point immediately preceding to the above-mentioned latest time point to calculate the difference therebetween. The difference calculator 33 delivers the respective difference data on its outputs, while notifying the controller 31 of the completion of the difference calculation (step s7).

Responsive thereto, the controller 31 commands the face area selector 34 to select the face area. In response to this command, the face area selector 34 checks the difference data. If the difference is zero, or close to zero, the face area selector 34 gives a decision that the face area is a stationary object, such as of a bronze statue or a poster, and eliminates it from face area selection, as indicated with a dotted square 103 in FIG. 3. Unless the difference is substantially equal to zero, the face area selector 34 designates the specified face area 101 as a selected face area (step steps s8, s9 and s10).

If the setting value P of the peak number of recognition of persons is set for the photographing mode (step s11), the number of the face areas selected is set to be not greater than P (step s11a). If the setting value of the peak number of persons is not set for the photographing mode, the face areas are selected so that the number of the face areas selected will be not greater than the maximum number M of recognition of the persons allowed by the hardware function of the digital camera 1 (step s12).

Upon completion of the selection of the face areas, the face area selector 34 notifies the controller 31 of that purport. Responsive thereto, the controller 31 commands the monitor display 60, over the internal bus 110, to display only the selected face areas of the preparatory image with the luminance thereof emphasized (step s13). Although the present embodiment is adapted to display the specified face area of the preparatory image with its luminance emphasized, such an area of the preparatory image may also be emphatically displayed by other methods whereby the operator may identify the specified face area in the preparatory image. Such other methods may include surrounding the outer contour line of the face area with a curved line, for instance.

In order to improve the precision in determining the face area, the face area selector 34 has the stationary object identifying quantity Q for each of the face areas of the preparatory image. In this case, if the difference value of the difference data is zero, the face area selector 34 adds a value of −1 to the quantity Q, that is, subtracts “1” from the quantity Q. If the difference value is not zero, a value of +1 is added to the quantity Q. This addition is performed at least N cycles. If, at some time point during the N cycles of this addition, the quantity Q is equal to zero, the face area selector 34 gives a decision that the subject being photographed is a stationary object to eliminate it as from face area selection. By so doing, such a situation may be prevented from occurring in which the area of interest is of a person intended to be selected but has happened to be devoid of movements, such as an eye not blinking for two cycles, so that it would otherwise erroneously be determined to be a stationary object.

The controller 31 then commands the optimum exposure focus calculator 35 to calculate an optimum exposure and focusing values. Responsive thereto, the optimum exposure focus calculator 35 calculates an optimum exposure value, that is, an exposure time, a stop value of the diaphragm and the optimum focusing value, of an area containing the selected face area in the middle. The optimum exposure focus calculator 35 then notifies the controller 31 of the completion of calculations of the optimum exposure and focusing (step s14).

Responsive thereto, the controller 31 commands the imaging unit 10 to control the diaphragm, based on the optimum light exposure value and the optimum focusing value, and to carry out the focusing operation. In response, the imaging unit 10 mechanically adjusts the diaphragm, not shown, and carries out the focusing operation, in readiness for live photographing, and notifies the controller 31 of the completion of the preparations (step s15). Responsive thereto, the controller 31 enters its ready state for live photographing.

The operator then depresses the shutter release button into its full stroke for live photographing. The shutter release unit 41 of the control panel 40 notifies the controller 31 of the central processor 30 of the purport that the shutter has been depressed into its full stroke (step s16). Responsive thereto, the controller 31 relinquishes its ready state for live photographing and commands live photographing to drive the imaging unit 10 with the optimum exposure time thus calculated. The imaging unit 10 then performs live photographing. The signal of the image thus captured is converted into digital data and forwarded as live photographed data to the image processor 21. The image processor 21 performs signal processing, inclusive of color compensation, gray scale correction and white balance adjustment, on the so converted digital data of the live photographed image, and routes the processed data over the internal bus 110 and the controller 31 to the image data storage 50 (step s17). The image data storage 50 stores the live photographed image thus received, and subsequently notifies the controller 31 of the purport of completion of storing the live photographed image (step s18).

If the photographing mode is set to the flash illumination mode (step s2a), and the shutter release button is depressed into its half stroke, the shutter release unit 41 commands the flash unit 43 to effect flash illumination. At the same time, the controller 31 commands the imaging unit 10 to perform photographing in synchronization with this flash illumination (step s2b). The imaging unit 10 photographs the subject to be photographed as the latest preparatory image (step s3). The preparatory image data, converted to digital data, is held by the image data storage 50 (step s4). The difference calculator 33 then calculates the above-mentioned difference. In general, with a person, the difference is liable to be detected because of blinking caused by flash illumination. The present embodiment takes advantage of this property and correctly recognizes a face area that exhibits the difference as being a person to reduce the risk of erroneous recognition that an object like the human being, such as a statue or poster, might be an image of a person. This state is shown as an example in FIG. 4.

In live photographing, that is, in case the shutter release button is depressed into its full stroke, the shutter release unit 41 similarly commands the flash unit 43 to effect flash illumination. The controller 31 also commands the imaging unit 10 to photograph a subject to be photographed in synchronization with the flash illumination (step s16c). Thus, the imaging unit 10 photographs the subject to be photographed as the latest live image (step s17). The digitized photographed live image data are stored via the image processor 21 in the image data storage 50 (step s18).

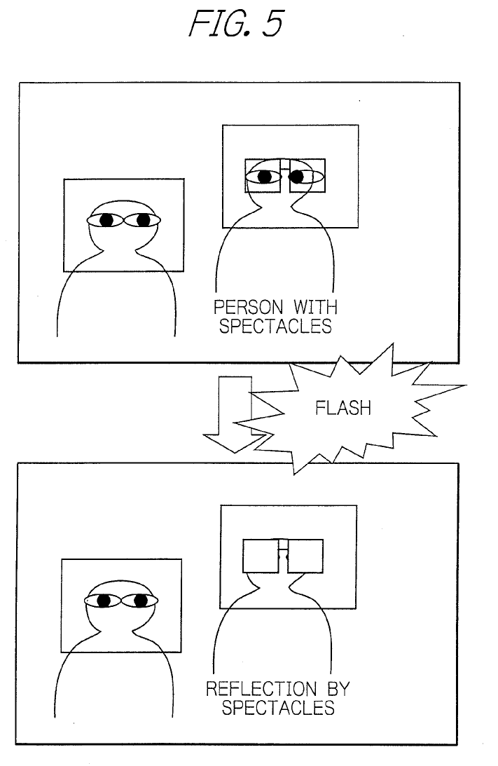

In the present embodiment, if the photographing mode is set to the flash mode, the flash unit 43 effects flash illumination at the time of depressing the shutter release button into its half stroke. In synchronism with this flash illumination, the imaging unit 10 photographs the subject to be photographed as the latest preparatory image. The image processor 21 outputs the so photographed subject as digitized preparatory image data. Thus, in the vicinity of a pattern portion likely to be recognized as an eye in any face area, if the above difference is greater than the predetermined value (step s8a), the difference calculator 33 determines that that portion of the light came from reflection by a lens of the eyeglasses. The controller 31 then makes a decision that “flash illumination is unnecessary when the shutter release button is depressed into its full stroke” (step s8b). In case the shutter release button is depressed into its full stroke, the controller 31 checks the ‘light illumination unneeded’ information (step s16b). If the ‘light illumination unneeded’ information has been set, the subject for photographing is photographed as the live photographed image without flash illumination (step s17). This state is shown in FIG. 5.

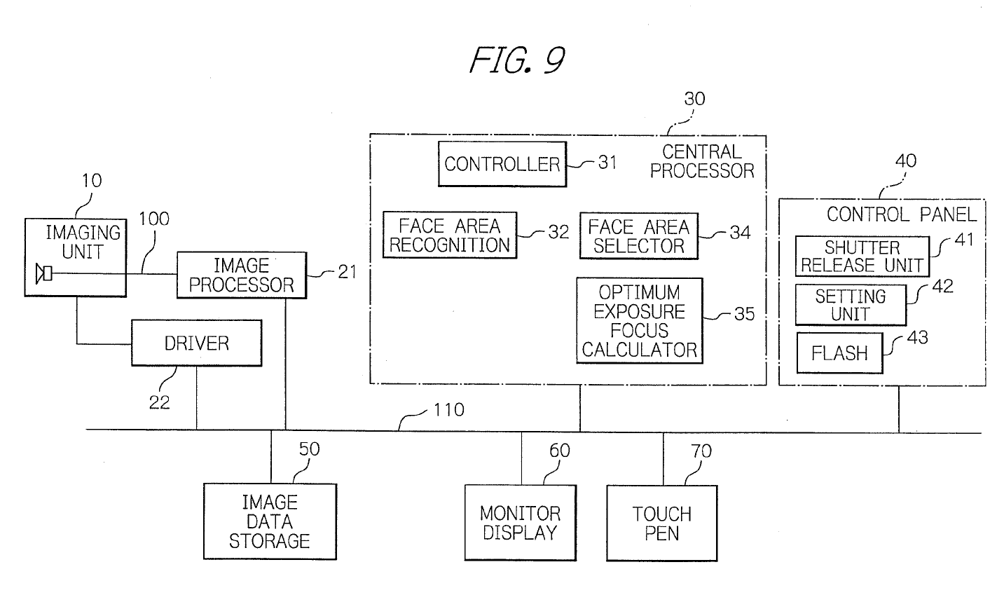

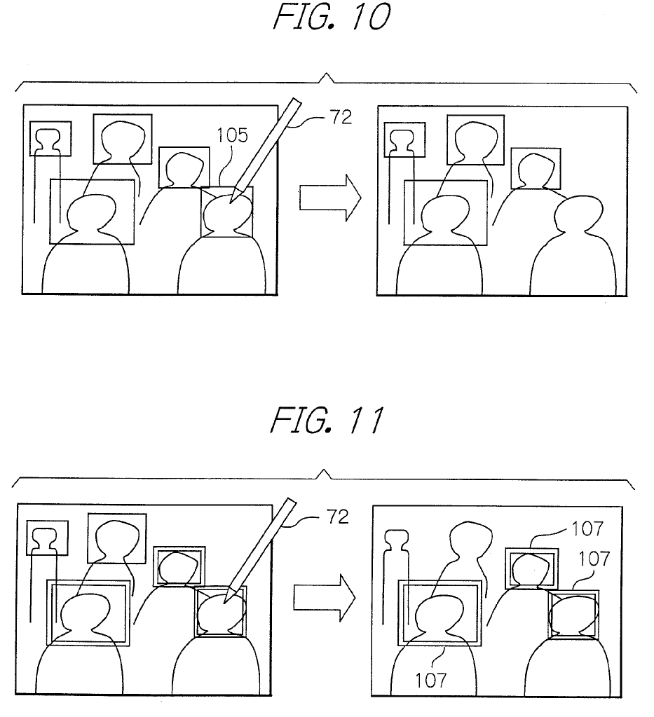

An alternative embodiment, that is, a second embodiment, of the digital camera of the present invention will now be described with reference to a schematic block diagram of FIG. 9. Like parts or components are specified by the same reference numerals or symbols and repetitive description is dispensed with. As compared to the constitution of the first embodiment, shown in and described with reference to FIG. 1, the constitution of the second embodiment is devoid of the difference calculator 33, and is newly provided with a touch pen unit 70, as shown in FIG. 9. The touch pen unit 70 has the function of controlling the touch pen function and outputting, when the display screen of the monitor display 60 is touched with a touch pen 72, FIG. 10, touch pen data in cooperative with the monitor display 60.

In the present alternative embodiment, the function of the face area selector 34 is not to calculate the difference of two face areas, but to delete the face area 105, FIG. 10, touched by the touch pen 72 from a set of identified face areas to set the so touched face area as the selected area. Alternatively, the face area touched by the touch pen may be selected as the identified area 107, FIG. 11.

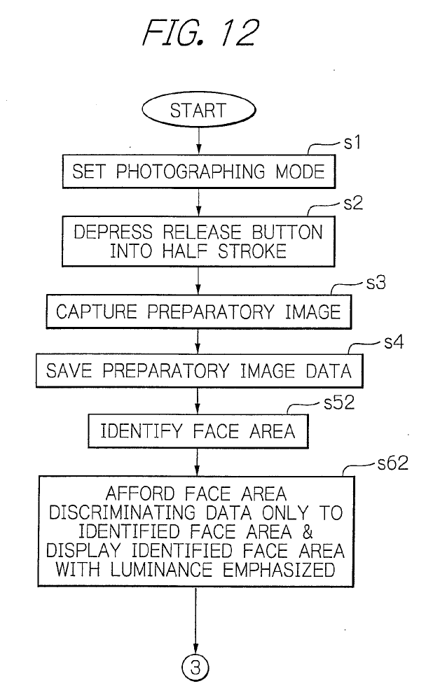

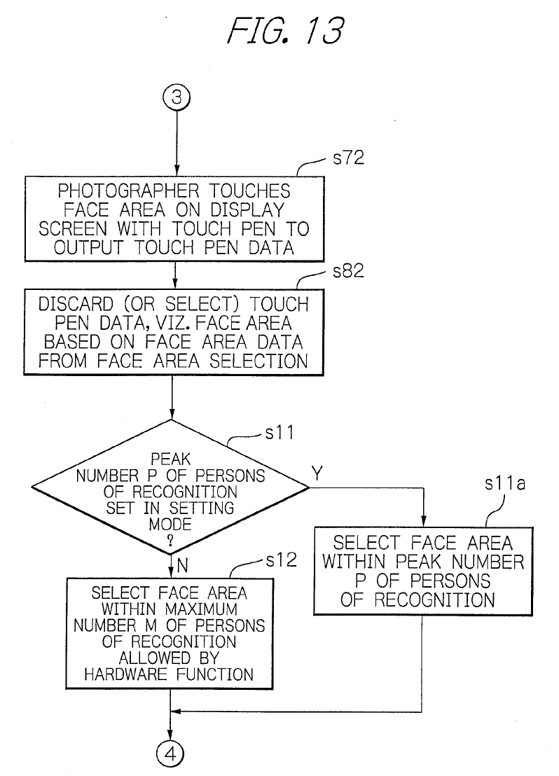

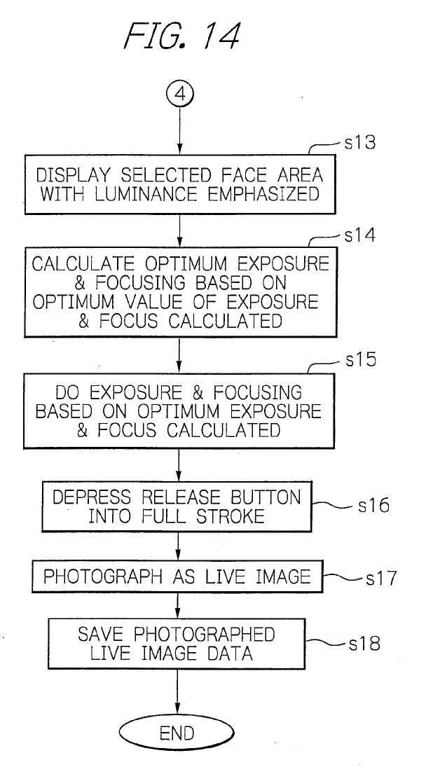

The operation of the digital camera 1 of the second embodiment will now be described with reference to the block diagram of FIG. 9 showing its constitution, the sketches of FIGS. 10 and 11, and the operational flowcharts of FIGS. 12, 13 and 14.

With the exception of the flash-related operation, the operation of the second embodiment differs from the operation of the first embodiment as to the method for selecting the face area. In more detail, in the first embodiment, the face area recognition subsection 32 recognizes a person of the preparatory image and identifies it as a face area (step s5). The monitor display 60 displays the identified face area with emphasis (step s6). Likewise, in the second embodiment, the face area recognition subsection 32 recognizes a person in the preparatory image and identifies it as a face area (step s52). The monitor display 60 affords face area discriminating data only to the face areas in the preparatory image on the display screen and demonstrates the face areas with the luminance thereof emphasized (step s62). The operator then touches, with a touch pen, desired one of the face areas demonstrated with emphasis on the display screen. The touch pen unit 70 then cooperates with the monitor display 60 and the face area recognition subsection 32 to output touch pen data, inclusive of the face area discriminating data that specifies the face area touched by the touch pen (step s72). In the example shown in FIG. 10, the face area selector 34 eliminates the face area relevant to the face area discriminating data of the touch pen data from face area selection. Alternatively, in the example shown in FIG. 11, the face area selector 34 selects the face area relevant to the face area discriminating data as the desired face area.

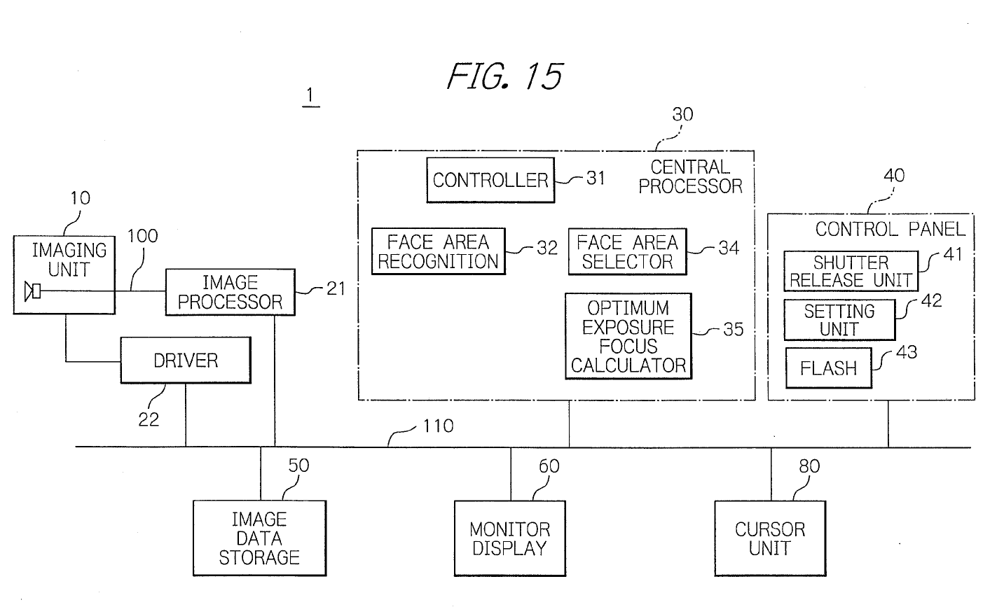

A further alternative embodiment, that is, a third embodiment, of the digital camera 1 according to the present invention will now be described based on the constitution shown in the schematic block diagram of FIG. 15. As may be seen from FIG. 15, the constitution of the third embodiment, as contrasted to that of the first embodiment, is devoid of the difference calculator 33, and is newly provided with a cursor unit 80. The cursor unit 80 has the function of controlling a cursor, displayed on the screen of the monitor display 60, and is adapted to point to a zone on the display screen with the cursor to output cursor data in cooperative with the monitor display 60.

The function of the face area selector 34 is to delete the face area, indicated by the cursor, from the set of face areas identified, and to exclude a face area, thus specified with the cursor, from a set of target face areas acting as a photographing reference. That is, the function of the face area selector 34 is not to calculate the difference of the two face areas as described above. It is of course possible to select the face area, thus specified with the cursor, as the desired target face area acting as the photographing reference.

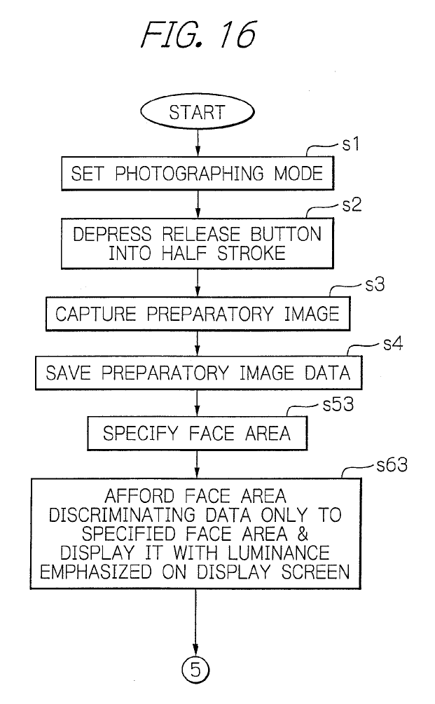

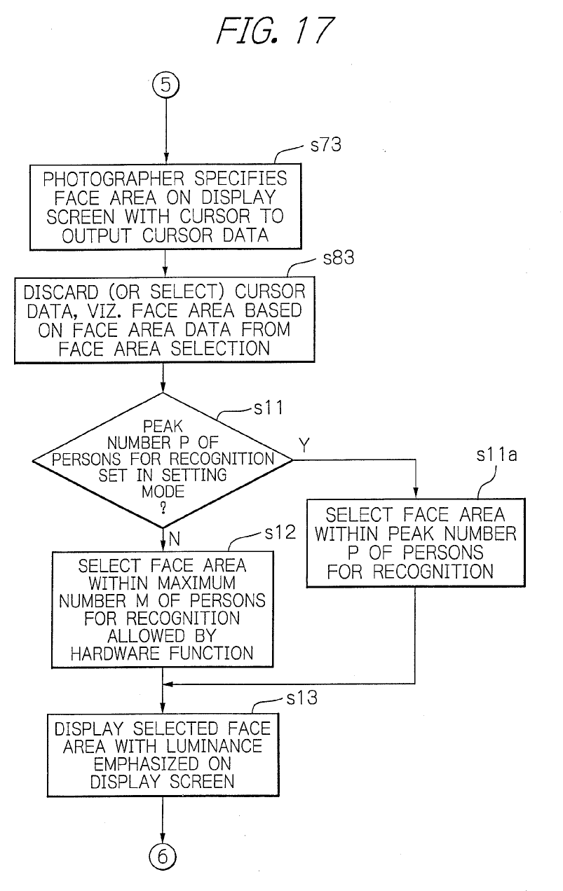

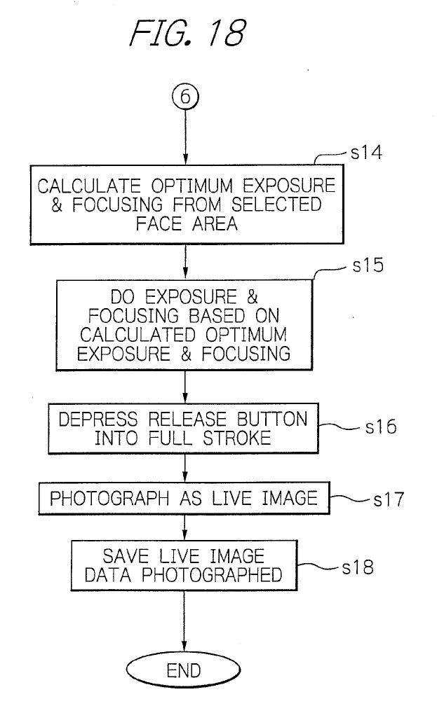

The operation of the digital camera of the present third embodiment will now be described. FIGS. 16, 17 and 18 are an operational flowchart of the third embodiment constituted as shown in FIG. 15. With the exception of the flash-related operation, the operation of the third embodiment differs from the operation of the first embodiment as to the method for selecting a face area. in more detail, in the first embodiment, the face area recognition subsection 32 recognizes a person of the preparatory image and specifies it as a face area (step s5). In the third embodiment, as in the first and second embodiments, the face area recognition subsection 32 recognizes a person of the preparatory image and identifies it as a face area (step s53). The monitor display 60 affords the face area discriminating data only to the specified face areas in the preparatory image on the display screen by way of performing the emphasizing demonstration (step s63).

With the third embodiment, the operator points to the face area, displayed with emphasis on the display screen, by a cursor operation. By so doing, the cursor unit 80 outputs cursor data, inclusive of the face area discriminating data, specifying the face area indicated by the cursor, in cooperative with the monitor display 60 and the face area recognition subsection 32 (step s73). Further, the face area selector 34 eliminates the face area, relevant to the cursor data, that is, the face area discriminating data, from selection of the set of face areas acting as the photographing reference (step s83). Alternatively, the face area selector 34 selects a face area, specified by the face area discriminating data, as the face area acting as the photographing reference.

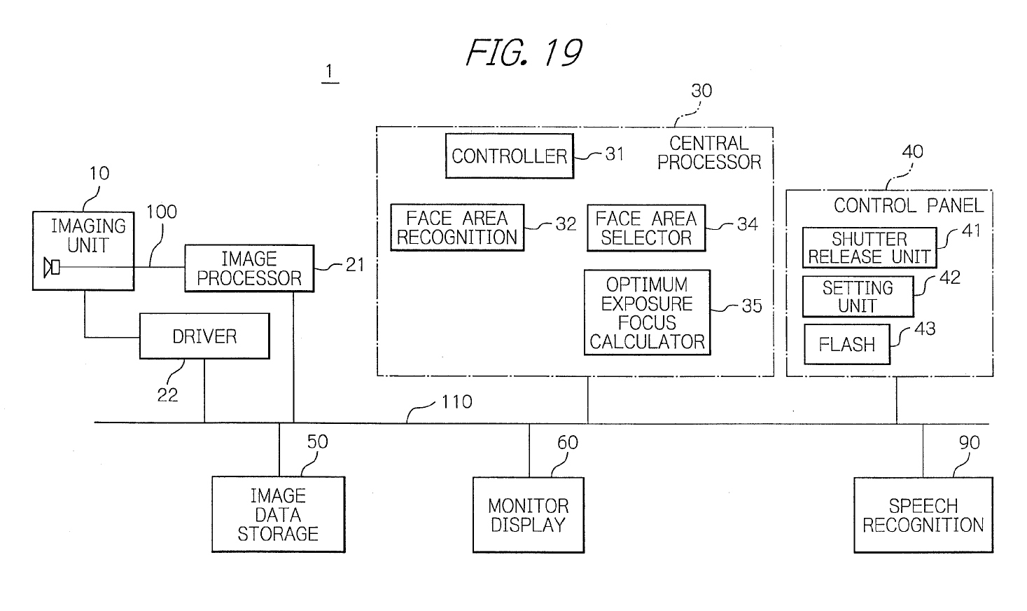

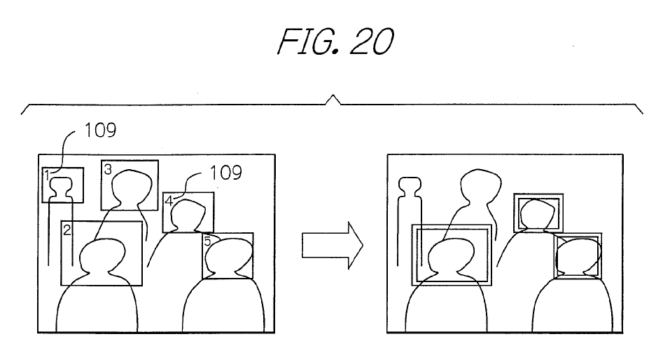

The constitution of the digital camera 1 of the fourth embodiment will now be described with reference to FIG. 19. As contrasted to the constitution of the first embodiment of FIG. 1, the constitution of the fourth embodiment, shown in FIG. 19, is devoid of the difference calculator 33, but is newly provided with a speech recognition subsection 90. The monitor display 60 also has the function of displaying face area discriminating data 109, such as numbers, alphabets or symbols, in each face area on the display screen of the monitor display 60, as depicted in the left sketch of FIG. 20.

The speech recognition subsection 90 includes a microphone, not shown, for collecting speech sound uttered by the operator, and has the function of recognizing the speech of the operator to output speech recognition data corresponding to the contents of the operator's speech. The face area selector 34 also is not designed to calculate the difference of two face areas on the time axis, as described above. Instead, the operator reads aloud the number, alphabet or the like of desired one of the areas on the display screen provided with the face area discriminating data 109, FIG. 20. The face area selector 34 deletes the face area, relevant to the face area discriminating data, read aloud and recognized as speech, from the set of specified face areas to eliminate it from face area selection. Of course, the face area, relevant to the face area discriminating data, recognized as speech, may be selected as the face area specified as the target of photographing reference.

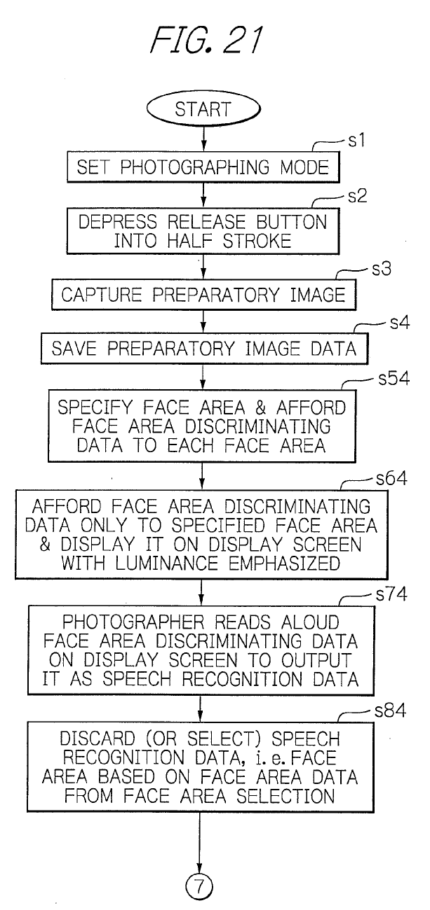

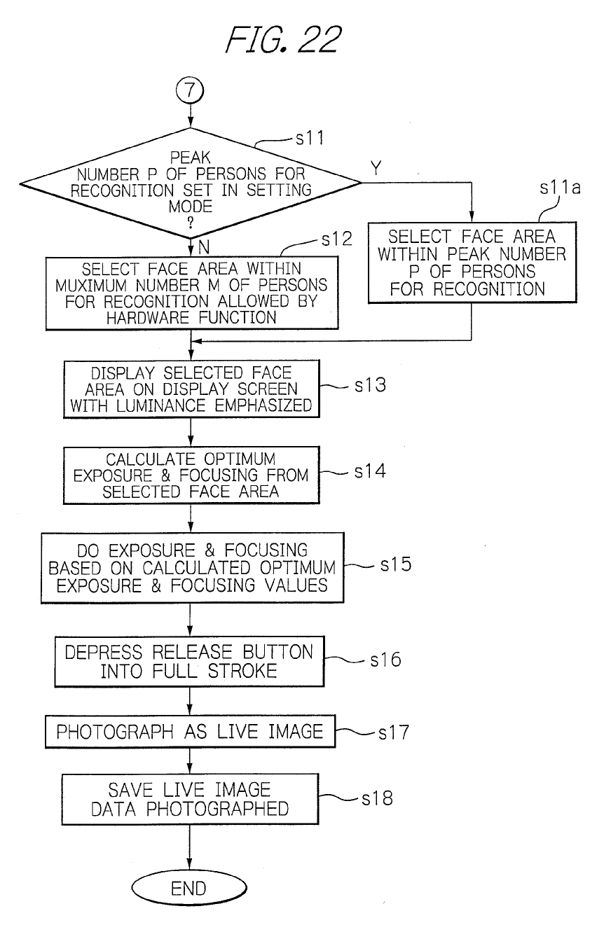

The operation of the digital camera 1 of the fourth embodiment will now be described. FIG. 20 includes sketches for illustrating the manner of selecting or refraining from selecting a face area based on speech. FIGS. 21 and 22 are an operational flowchart corresponding thereto.

With the exception of the flash-related operation, the operation of the fourth embodiment differs from the operation of the first embodiment as to the method for selecting face areas. More specifically, as in the first, second and third embodiments, the face area recognition subsection 32 recognizes persons of a preparatory image and specifies them as face areas (step s5). The monitor display 60 displays the specified face areas with emphasis (step s6). The face area recognition subsection 32 recognizes the persons of the preparatory image and specifies them as face areas.

In the fourth embodiment, face area discriminating data are afforded to each face area (step s54). The monitor display 60 affords face area discriminating data 109, FIG. 20, only to the specified face areas in the preparatory image on the display screen by way of display with emphasis (step s64). The operator then reads aloud the face area discriminating data 109 provided to the face area desired to be selected. The speech recognition subsection 90 recognizes the speech and outputs speech recognition data relevant to the speech (step s74). The face area selector 34 eliminates the face area relevant to the face area discriminating data from the set of face areas acting as the target for photographing reference (step s84). This state is shown in FIG. 20. The face areas relevant to the face area discriminating data may be selected as the face area acting as the target for photographing reference (step s84). In the example shown, area numbers “2”, “4” and “5” are read aloud and become target areas.

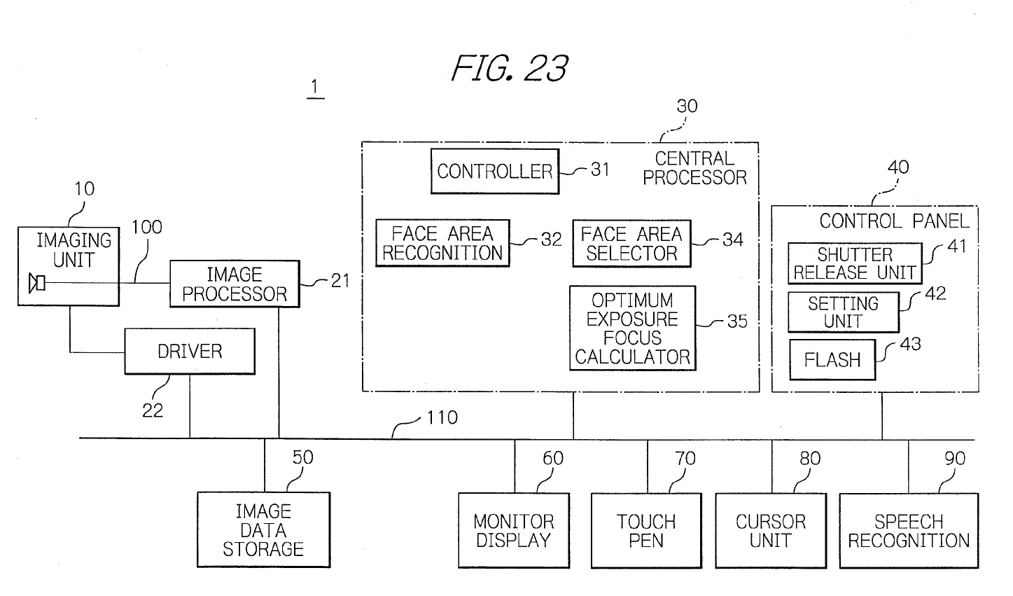

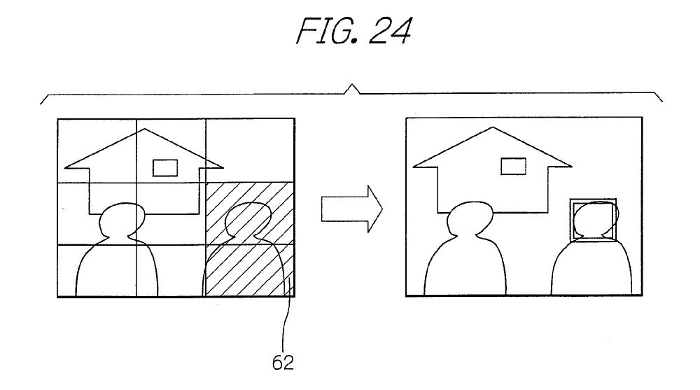

The constitution of a fifth embodiment of the digital camera. 1 will now be described with reference to FIG. 23. As contrasted to the constitution of the first embodiment, the constitution of the fifth embodiment is devoid of the difference calculator 33, and is instead provided with any or all of the touch pen unit 70, cursor unit 80 and speech recognition subsection 90, as shown in FIG. 23.

The monitor display 60 has the functions of the first to fourth embodiments and, in addition, has the following function. More specifically, with reference to FIG. 24, the monitor display 60 has its display screen sectioned into a plurality of partitioned partial areas 62, each of which is indicated with partial area discriminating data specific thereto. The operator touches intended one of the partial areas 62 displayed with a touch pen, points it by a cursor, or reads it aloud its discriminating data to thereby specify that partial area. In the example shown in FIG. 24, the so specified partial areas are indicated with hatching. The face area in the so specified areas 62 is to be a selected face area or alternatively a face area to be eliminated from face selection. The monitor display 60 displays various settings of setting modes on the display screen if such settings are made. The monitor display 60 outputs, when the display screen is touched with the touch pen, touch pen data in cooperative with the touch pen unit 70. When the cursor points to a zone on the display screen, the monitor display 60 also outputs cursor data in cooperative with the cursor unit 80.

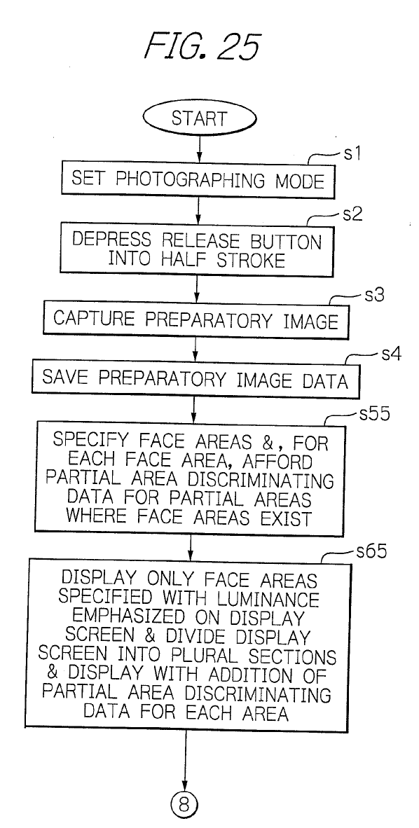

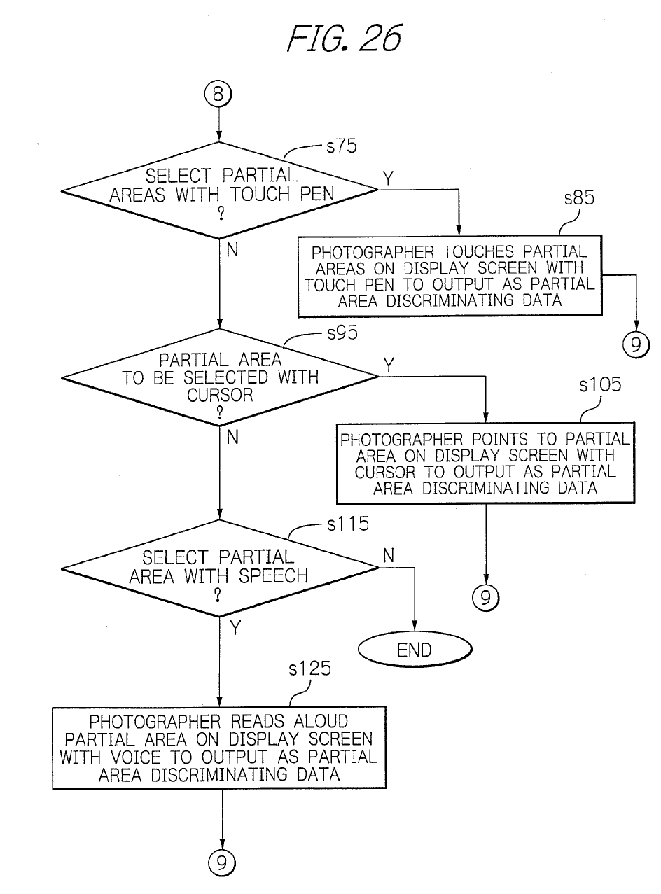

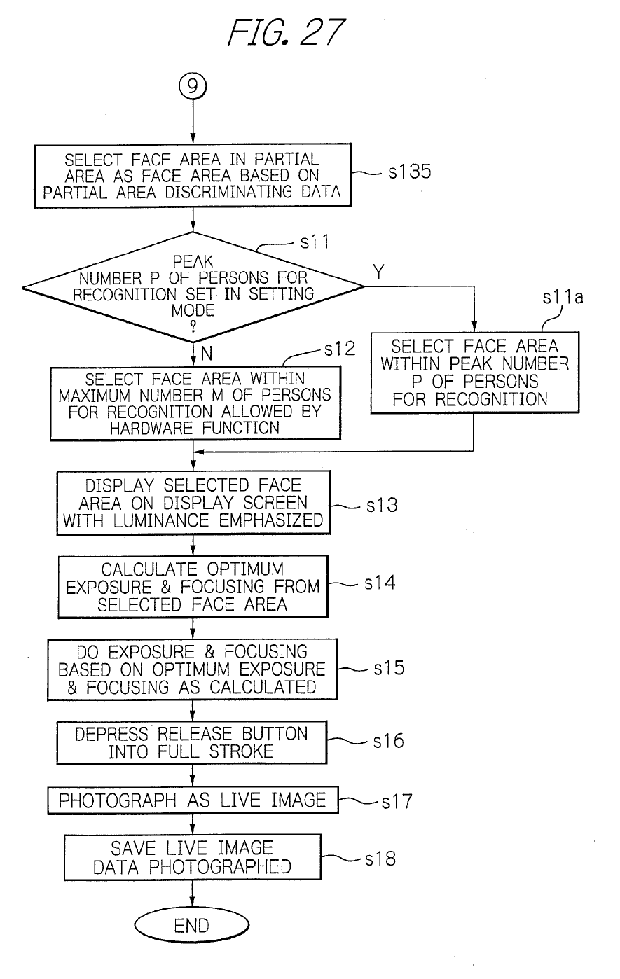

The operation of the digital camera 1 of the fifth embodiment will now be described. FIGS. 25, 26 and 27 is a flowchart for illustrating the operation.

Again with the exception of the flash-related operation, the operation of the fifth embodiment differs from the operation of the first to fourth operations as to the method for selecting face areas. In the fifth embodiment, the face area recognition subsection 32 recognizes the faces of persons in a preparatory image and specifies them as respective face areas. In addition, the face area recognition subsection 32 affords the discriminating data of at least one partial area to the so specified face areas. This partial area discriminating data indicates in which of the partial areas of the display screen the so specified face areas are located (step s55).

The monitor display 60 also displays the specified face areas 62 with emphasis on the display screen with its partial areas partitioned, as shown in FIG. 24. In the respective partial areas, there are entered and displayed partial area discriminating data (step s65). The operator specifies desired one of the partial areas by touching the partial area with the touch pen (step s75), indicating the partial area with the cursor (step s95), or reading aloud the discriminating data for the partial area (step s115).

When the operator has touched the partial area of the display screen with the touch pen, the touch pen unit 70 outputs the partial area discriminating data of the partial area as touch pen data (step s85). If the operator has specified the partial area of the display screen with the cursor, the cursor unit 80 outputs the partial area discriminating data as cursor data (step s105). If the operator has read aloud the partial area discriminating data by voice, the speech recognition subsection 90 outputs the partial area discriminating data of the partial areas as speech recognition data (step s125).

From the touch pen data, cursor data or speech recognition data, that is, the partial area discriminating data, the face area selector 34 eliminates the face areas, present in the partial areas in question, from face area selection (step s135). Alternatively, the face area selector 34 selects the faces areas, present in the partial areas, specified by the partial area discriminating data, as face areas of the photographing reference.

The respective embodiments of the present invention, described above, may give rise to a variety of meritorious effects. With the first embodiment, the difference is detected between two face areas at respective different time points. The difference is detected in case there are eye movements, caused by blinking, whereas no difference is detected with, e.g. a poster or with a bronze statue. Such property is exploited for identifying the face area. If the difference between two preparatory images, neighboring to each other on the time axis, is zero or nearly zero, the subject for photographing is determined to be a stationary object and is eliminated from face area selection. It is thus possible to reduce the risk of erroneous operations of selecting an object other than the face of a person as a face area.

There are however cases where, even with a person, there is no movement between two time points, that is, the difference therebetween is zero. Hence, there persists the possibility that a person is erroneously determined to be a stationary object and fails to be selected as a face area. In order to prevent this from occurring, detection of the difference of the face areas is carried out in the first embodiment plural numbers of times. For example, if, on detection of the above difference, the difference is zero, a value of −1 is added to a quantity Q that has its initial value of N. If the difference is not zero, a value of +1 is added. This sequence of operations is carried out plural numbers of times. If the quantity Q becomes ultimately equal to zero, the face area in question is determined to be a stationary object and is eliminated from face area selection, thus reducing the erroneous recognition of objects as persons.

Flash illumination is also generated at the time of thrusting the shutter release button to its half stroke to induce eye movements, such as blinking, of a person to assure facilitated difference detection. By so doing, it is possible to further reduce the possibility of erroneous recognition of a stationary object as a person. Although the illustrated embodiments use visual means, that is, flash illumination, it is also possible to use acoustic means, such as beeps.

If the value of difference data exceeds a predetermined magnitude in the vicinity of an eye in a face area due to flash illumination in the preparatory image step, such a state is determined to be ascribable to the flash beam reflected by spectacles. In such a case, flash illumination will be inhibited at the time of the shutter release button thrust into its full for live photographing. By so doing, a photo may be produced in which reflection of light by spectacles is avoided.

In the second embodiment, a face area on the display screen is touched by a touch pen to select the face area as a face area or to discard it from face area selection. In the third embodiment, whether to select the face area on the display screen is indicated by a cursor. In the fourth embodiment, an operator reads aloud the face area discriminating data entered in the face area on the display screen to select or discard the face area. In the fifth embodiment, the display screen is divided into a plurality of partial areas, of which the discriminating data are entered in the respective partial areas and displayed. The partial area discriminating data are discriminated by recognition of the operator's speech, for example, thereby selecting or discarding the face area in the partial area. This allows the operator to make free selection of the face area.

In any of the above embodiments, an operator may set the incidental peak number P of persons for recognition within the maximum number M of recognition of persons, as one of photographing modes. In this case, if the number of persons desired to be photographed is predetermined, there is no risk that the number of selected face areas is increased beyond this number. Hence, the operator may perform face recognition for only the persons desired to be photographed.

The entire disclosure of Japanese patent application No. 2007-257998 filed on Oct. 1, 2007, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A digital camera comprising:
an imaging unit for capturing an image of an object field to produce an image signal representing the subject field;
a shutter operating unit including a shutter release button having a half stroke when depressed to instruct capturing a preparatory image of the subject field and having a full stroke when depressed to instruct capturing a live image of the subject field;
a controller for controlling said imaging unit to capture the subject field at a first time when the shutter release button is depressed into the half stroke to cause said imaging unit to produce preparatory image data, and to capture the subject field at a second time when the shutter release button is depressed into the full stroke to cause said imaging unit to produce live image data;
an image data storage for storing the preparatory image data and the live image data;
a face area recognition subsection for recognizing a pattern equivalent to a face of a person in the preparatory image data stored to identify the pattern as a face area, and for affording face area discriminating data specific for the face area;
a difference calculator for comparing a face area of interest in the preparatory image at a time point closest to a current time point with the face area corresponding thereto in the preparatory image at a time point immediately preceding to the closest time point, and for calculating a difference therebetween;
a face area selector for determining the face area to be a stationary object in case the difference is substantially equal to zero, and for excluding the face area determined from face area selection; and
a display unit for visually displaying the preparatory image at the closest time point and for displaying the selected face area in the preparatory image with emphasis;
said controller being responsive at the second time to the selected face area to instruct said imaging unit to perform live photographing of the subject field with an optimum exposure and an optimum focus.

2. The digital camera in accordance with claim 1, wherein said face area selector has a stationary object identifying value specific for the face area of the preparatory image and having an initial value equal to a natural number,
said face area selector decrementing the identifying value in case the difference is substantially equal to zero and incrementing the identifying value in case the difference is different from zero,
said face area selector performing the incrementing a predetermined number of cycles,
said face area selector determining, when the identifying value is equal to zero, the face area to be a stationary object to eliminate the face area of interest from the face area selection.

3. The digital camera in accordance with claim 1, further comprising a light illumination unit for illuminating light to the subject field,
said controller controlling, when said camera is set to a light illumination mode, said light illumination unit to illuminate light at the first time, and controlling said imaging unit to photograph the subject field, in synchronization with the light illumination, as a preparatory image,
said face area selector determining a face area in the preparatory image synchronized with the light illumination and the corresponding face area in a preparatory image immediately preceding and having the difference substantially equal to zero as a stationary object, and excluding the face area from the face area selection.

4. The digital camera according to claim 3, wherein said difference calculator determines a face area in the preparatory image synchronized with the light illumination and the corresponding face area in the immediately preceding preparatory image having the difference in a vicinity of an eye greater than a predetermined value as a face area where the light has been reflected by spectacles to cause said light illumination unit not to be driven at the second time.

5. The digital camera in accordance with claim 1, further comprising a touch pen unit for allowing an operator to touch an area of the image displayed on a picture display screen of said display unit to output data specifying an area in the image,
said controller eliminating, when the face area displayed with emphasis on said display unit is touched by said touch pen, the face area touched from the face area selection.

6. The digital camera in accordance with claim 1, further comprising a cursor unit for allowing an operator to point to an area of the image displayed on a display screen of said display unit by a cursor to output cursor data that specifies the area in the image,
said controller eliminating, when the face area displayed with emphasis on said display unit is specified by said cursor unit, the face area from the face area selection.

7. The digital camera in accordance with claim 1, further comprising a touch pen unit for allowing an operator to touch an area in the image displayed on a display screen of said display unit by a touch pen to output data that specifies the area in the image,
said controller setting, when the face area displayed with emphasis on said display unit by said touch pen, the face area thus touched to be a selected face area.

8. The digital camera in accordance with claim 1, further comprising a cursor unit for allowing an operator to point to an area in the image displayed on a display screen of said display unit by a cursor to output data that specifies the area in the image,
said controller setting, when the face area displayed with emphasis on said display unit is specified by said cursor unit, the face area thus specified to be a selected face area.

9. The digital camera in accordance with claim 1, wherein said camera has a maximum number of persons of recognition,
said face area recognition subsection having a peak number of persons set to be not greater than the maximum number to allow the face areas to be selected so that the maximum number of persons of recognition is not surpassed.

10. The digital camera in accordance with claim 1, further comprising a speech recognition subsection for receiving speech of an operator to recognize the speech to output speech recognition data,
said face area recognition subsection affording face area discriminating data to the face area identified,
said display unit displaying the identified face area along with the face area discriminating data,
said face area selector selecting a face area, relevant to the face area discriminating data included in the speech recognition data, as a selected face area,
whereby the operator reads aloud the face area discriminating data of the face area displayed to thereby render the face area thus read aloud the face area selected.

11. The digital camera in accordance with claim 5, wherein said display screen of said display unit is divided into a plurality of partial areas,
said face area recognition subsection affording partial area discriminating data to the face area identified, the partial area discriminating data indicating in which of the partial areas the face area identified is located,
said touch pen unit generating discriminating data of the partial area touched by said touch pen,
said face area recognition subsection selecting the face area relevant to the partial area discriminating data as a face area,
whereby the operator touches the partial area displayed on said display screen with said touch pen to thereby render the face present in the partial area touched the face area selected.

12. The digital camera in accordance with claim 6, wherein said display screen of said display unit is divided into a plurality of partial areas,
said face area recognition subsection affording partial area discriminating data to the identified face area, the partial area discriminating data indicating in which of the partial areas the face area identified is located,
said cursor unit generating partial area discriminating data indicated by the cursor data,
said face area recognition subsection selecting the face area relevant to the cursor data as a selected face area,
whereby an operator indicates a partial area displayed on said display screen with a cursor to thereby render the face area within the indicated partial area a selected face area.

13. The digital camera in accordance with claim 10, wherein said display screen of said display unit is divided into a plurality of partial areas,
said face area recognition subsection affording partial area discriminating data to the face area identified, the partial area discriminating data indicating in which of the partial areas the face area identified is located,
said speech recognition subsection selecting a face area relevant to the partial area discriminating data included in the speech recognition data as a selected face area,
whereby an operator reads aloud the partial area discriminating data displayed on said display screen to thereby render the face area present in the partial area read out a selected face area.

14. A method for photographing with a digital camera including an imaging unit for photographing a subject field to produce an image signal representing the subject field, and a shutter operating unit including a shutter release button having a half stroke when depressed to instruct capturing a preparatory image of the subject field and having a full stroke when depressed to instruct capturing a live image of the subject field, comprising the steps of:
commanding capturing a preparatory image at a first time when the shutter release button is depressed into the half stroke;
photographing a subject field as a preparatory image in response to a photographing command to generate preparatory image data;
storing the preparatory image data produced;
recognizing a face of a person in the preparatory image data stored to identify the face as a face area, and affording face area discriminating data specific to the face area;
visually displaying a preparatory image at a time point closest to a current time point;
comparing a face area of interest in the preparatory image at the closest time point with a face area corresponding thereto in a preparatory image immediately preceding to the closest time point to calculate a difference therebetween;
determining the identified face area of interest to be a stationary object when the difference is substantially equal to zero to eliminate the face area of interest from face area selection, and selecting the identified face area as a selected face area when the difference is not zero;
displaying the selected face area with emphasis in the preparatory image at the latest time point displayed;
calculating an optimum exposure and an optimum focusing based on the face area selected; and
capturing a live image of the subject field at the optimum exposure and at optimum focusing at a second time when the shutter button is depressed into the full stroke.
